(19) United States
(12) Patent Application Publication
(10) Pub. No.: US 2018/0101909 A1
(43) Pub. Date: Apr. 12, 2018

(54) Apparatus and Method for Assisting Existing Social Networks to Fund and Support Ventures

(71) Applicant: Club Funding Ltd., London (GB)

(72) Inventor: Robert Silman, London (GB)

(21) Appl. No.: 15/821,782

(22) Filed: Nov. 23, 2017

Related U.S. Application Data
(63) Continuation-in-part of application No. 15/727,774, filed on Oct. 9, 2017.
(60) Provisional application No. 62/406,434, filed on Oct. 11, 2016.
(60) Provisional application No. 62/528,560, filed on Jul. 5, 2017.

(51) Int. Cl. G06Q 40/06; G06Q 50/00

(52) U.S. Cl. CPC G06Q 40/06; H04L 63/10; G06Q 50/01

(57) ABSTRACT

A method and apparatus for funding and supporting ventures using online funding and supporting sites which extends beyond the network of colleagues, friends and family to reach larger existing social networks is described. In some cases, the method and apparatus protects confidentiality for innovative businesses seeking funding using online funding sites. One embodiment of this disclosure includes a social network funding site owned by members for funding ventures that are proposed by its members and funded by such members. Another embodiment of this disclosure includes a social network funding site owned by members for funding ventures that are proposed by non-members and funded by members of the site. Another embodiment of this disclosure includes a social network funding with two platforms (members and non-members) and two affinities (related to members and non-members). Another embodiment of this disclosure includes an umbrella provider that takes on support services necessary for the successful operation of a “reward”- or “equity”-based social network. Another embodiment of this disclosure includes a non-financial support paradigm between members in the form of targeted messaging.

### RELATED APPLICATION

This application is a continuation-in-part of U.S. patent application Ser. No. 15/727,774, filed on Oct. 9, 2017, which claims the benefit of two U.S. Provisional patent applications:

1. Ser. No. 62/406,434 filed on Oct. 11, 2016; and

2. Ser. No. 62/528,560 filed on Jul. 5, 2017.

### FIELD OF THE DISCLOSURE

The present disclosure is directed to providing existing social networks with an apparatus and method for funding and supporting ventures within and outside their social network on a web funding site

### BACKGROUND

In this application, “crowd funding” is a funding site on the web where worthwhile causes and businesses may raise funds from the public. This may consist of two principal variants: reward and equity.

“Reward”-based crowd funding is the platform where the public is asked to fund a venture without being offered a financial stake in it. It is a form of philanthropy and the reward can be as basic as an acknowledgement. In other cases, the reward can be “in kind,” as for example the offer of a free software program in return for backing its development.

There have been successes with reward-based crowd funding. For example, hospitals may raise money for new ventures by appealing to patients and ex-patients, or movie directors can raise money for their movies by appealing to fans, or parents can raise money for medical treatment for their children by appealing to the general public through a media campaign. But unless there is a ready-made support group or are a celebrity or have a high profile venture, reward-based crowd funding is mostly a way of soliciting from people already known to the solicitor. The problem with reward-based crowd funding is that there are so many individuals seeking support for so many worthy ventures that the public which funds any particular venture usually ends up as the beneficiary's own network of colleagues, friends and family. There is little chance that a casual visitor to a crowd funding site will stumble across a specific venture amidst the many other ventures placed on the site. What happens in practice is that those who solicit funds contact everyone they know personally (by e-mail, text, phone call, etc.) to give them the link to their posting on the crowd funding site. Their colleagues, friends and family have an affinity with them because they know them; hence it is their personal contacts rather than the general public that, mostly, fund their ventures. The fundamental problem with reward-based crowd funding for both those seeking funds and those offering funds is that there is no real “crowd”; it is mostly people funding each other within a social network of colleagues, friends and family.

“Equity”-based crowd funding is a platform where ventures may raise funds from the public in return for a financial stake in the venture (share, convertible note, etc.). In this instance regulatory compliance by a body like the SEC in the USA or the FCA in the UK govern the operation of the site. The public who can fund the ventures might be restricted by such bodies to sophisticated investors or high net worth individuals. Also, the Crowd Funding site might only accept ventures of a certain category (e.g. medical innovation or ethical enterprises) thereby appealing to a niche public specifically attracted to that category of investment. The investors receive a financial stake in the venture proportionate to their contribution and participate in the potential financial success of the venture based on their level of financial support. This variant is particularly suited to the funding of start-up businesses seeking early funding.

The principal problem with equity-based crowd funding is that it precludes two sorts of investment. It is not suited to a small-scale start-up where the aims and ambitions of the business do not interest an investment community and where the funding requirements exceed the social network of colleagues, friends and family. It is also not suited to innovative ventures which require confidentiality. The more successfully an innovative venture promotes itself via a crowd funding site, the more it alerts potential competitors to its value. Crowd funding thus neglects innovative businesses which aim high and carry the correspondingly high risk of failure, particularly when the risk of failure is augmented by premature public disclosure on a crowd funding site.

### SUMMARY OF THE INVENTION

In accordance with some embodiments, this disclosure provides for a method and apparatus for funding and support ventures using online funding and support sites. These sites extend beyond the network of colleagues, friends and family to reach larger existing social networks. In some cases, the method and apparatus protects confidentiality for innovative businesses seeking funding using online funding sites.

Specifically, one embodiment of this disclosure includes a social network funding site owned by members for funding ventures that are proposed by its members and funded by such members.

Another embodiment of this disclosure includes a social network funding site owned by members for funding ventures that are proposed by non-members and funded by members of the site.

Another embodiment of this disclosure includes a social network funding with two platforms (members and non-members) and two affinities (related to members and non-members).

Another embodiment of this disclosure includes an umbrella provider that takes on support services necessary for the successful operation of a “reward”- or “equity”-based social network.

Another embodiment of this disclosure includes a non-financial support paradigm between members in the form of targeted messaging.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a flow chart illustrating current crowd funding sites that separate the owners of the site from the users of the site.

FIG. 2 is a representation of various existing social networks, in accordance with some embodiments.

FIG. 3 is a flow chart illustrating a social network funding site that is owned by members for funding ventures proposed by members and funded by members, in accordance with some embodiments.

FIG. 4 is a flow chart illustrating a social network funding site that is owned by members for funding ventures proposed by non-members and funded by members, in accordance with some embodiments.

FIG. 5 is a flow chart illustrating a social network funding site that has: (1) a member platform where members can contribute to ventures proposed by members; and (2) a non-member platform where members can contribute to ventures proposed by non-members, in accordance with some embodiments.

FIG. 6 is a flow chart illustrating a crowd funding sites that generate revenue to support their costs.

FIG. 7 is a flow chart illustrating an umbrella provider that may provide most of the services required by a social network funding site for reward ventures, in accordance with some embodiments.

FIG. 8 is a flow chart illustrating an umbrella provider that may provide most of the services required by a social network funding site for reward and equity ventures, in accordance with some embodiments.

FIG. 9 is a flow chart illustrating a possible transaction flow to and from an umbrella provider and a social network funding site, in accordance with some embodiments.

FIG. 10 is a flow chart illustrating the add-on benefit of an umbrella provider for social network funding sites, in accordance with some embodiments.

FIG. 11 is a flow chart illustrating the operation of non-financial support between members in the form of targeted messaging, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

There are number of models by which a social network may expand funding ventures using online funding sites that extends beyond the network of colleagues, friends and family to reach larger networks.

### I. A SOCIAL NETWORK FUNDING SITE OWNED BY MEMBERS FOR FUNDING VENTURES PROPOSED BY MEMBERS AND FUNDED BY MEMBERS

One embodiment of this disclosure includes a social network funding site owned by members for funding ventures that are proposed by its members and funded by those members.

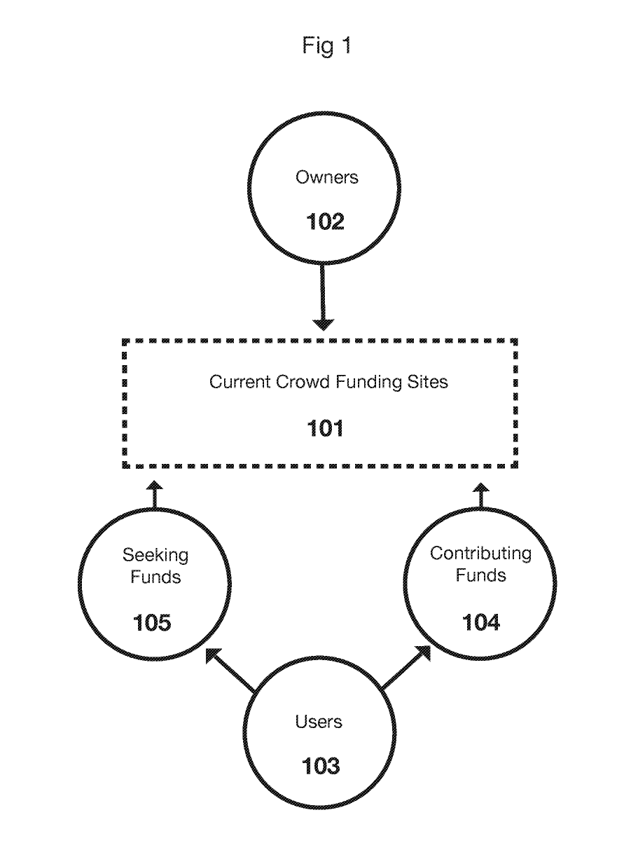

FIG. 1 is an illustration as to how current crowd funding sites 101 separate the owners of the site 102 from the users of the site 103. The owners are mostly the individuals, companies, organizations, etc., that create and operate the site. The owners target two sets of users; the public contributing funds 104, and the public seeking funds 105. Occasionally, if an owner is large enough and has a large network of followers (e.g. a famous sports team or a famous charity) the owner can be the sole user seeking funds (i.e. a specifically-tailored crowd funding site) and the public contributing funds will likely be their followers.

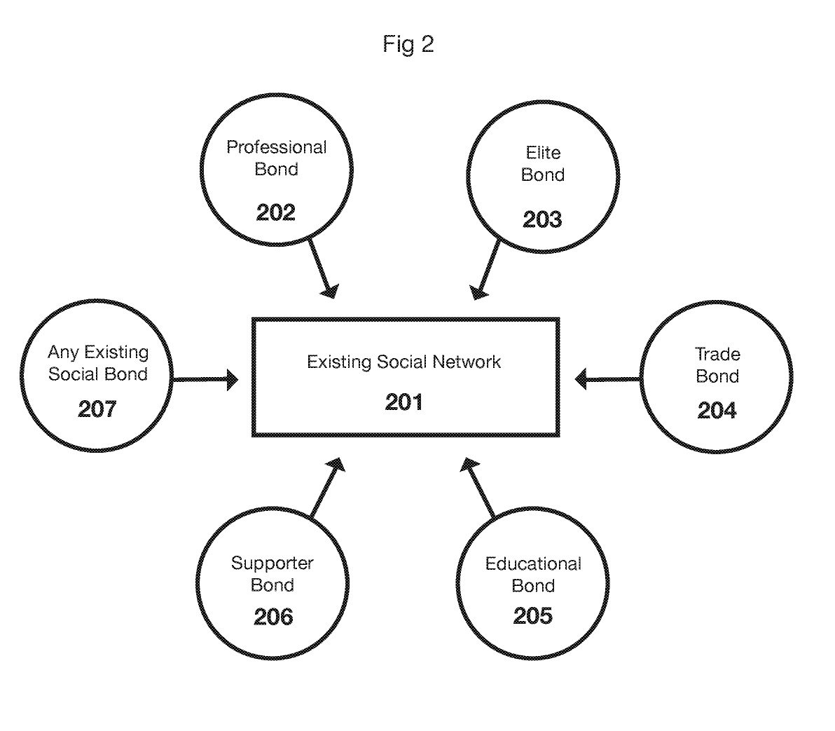

Described further herein are social network funding sites where the owners and users are coupled. Such sites use an existing social network 201, which is illustrated in FIG. 2. This existing social network 201 may be a professional network such as a doctors' network or a lawyers' network where the network is composed of those with a legally approved qualification 202. It may be an elite network such as the American Academy of Motion Picture Arts and Sciences network or the National Academy of Sciences network where the network is composed of those who have been elected or invited 203. It may be a trade network such as the American Society of Travel Agents network or The American Home Furnishings Alliance network where the network is composed of those who share a common trade 204. It may be an educational network such as The Old Pauline Club network or the Harvard Alumni Association network where the network is composed of the graduates and alumni of a common school or university 205. It may be a supporter network such as the Rolling Stones Fan Club network or the Jaguar E-type Club network where the network is composed of those who share an enthusiasm for a common entity 206. Alternatively, an existing social network is any network where individuals are linked by an existing social bond 207.

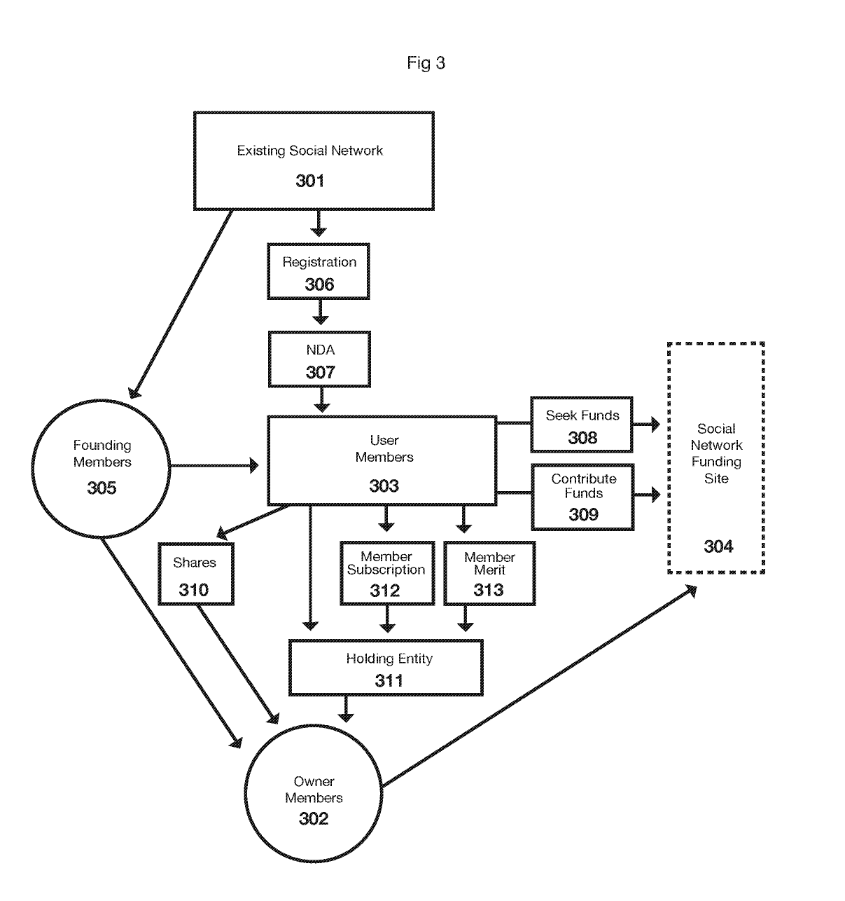

FIG. 3 illustrates how individuals from an existing social network 301 may be both owner members 302 and user members 303 of a social network funding site 304. One or several individuals from an existing social network create and own a site where they are the founding members 305. The founding members create the site so that only individuals from the same existing social network are permitted to be member users of the site. There is a registration process 306 to confirm that the potential member is from the existing social network; and a confidentiality/nondisclosure agreement 307 where the potential member agrees to keep all ventures posted on the site confidential. After completing the registration process the potential member is accepted as a member 303 who can use the site to solicit funds for ventures from other members 308 and/or to contribute funds for ventures posted by other members 309. The members might be offered co-ownership of the site. The co-ownership might be via a personal participation in shares 310 or via a holding entity 311 for all members who use the site 303 or for those members who pay a subscription (monthly, annual or lifetime) 312 or for those members who most contribute to the success of the site (by financial contributions or other means) 313. The more the members who use the site 303 are the members who own the site 302, the more likely the site will attract individuals from the existing social network 301 to become members of the social network funding site 304.

### II. A SOCIAL NETWORK FUNDING SITE OWNED BY MEMBERS FOR FUNDING VENTURES PROPOSED BY NON-MEMBERS AND FUNDED BY MEMBERS

Another embodiment of this disclosure includes a social network funding site owned by members for funding ventures that are proposed by non-members and funded by members of the site.

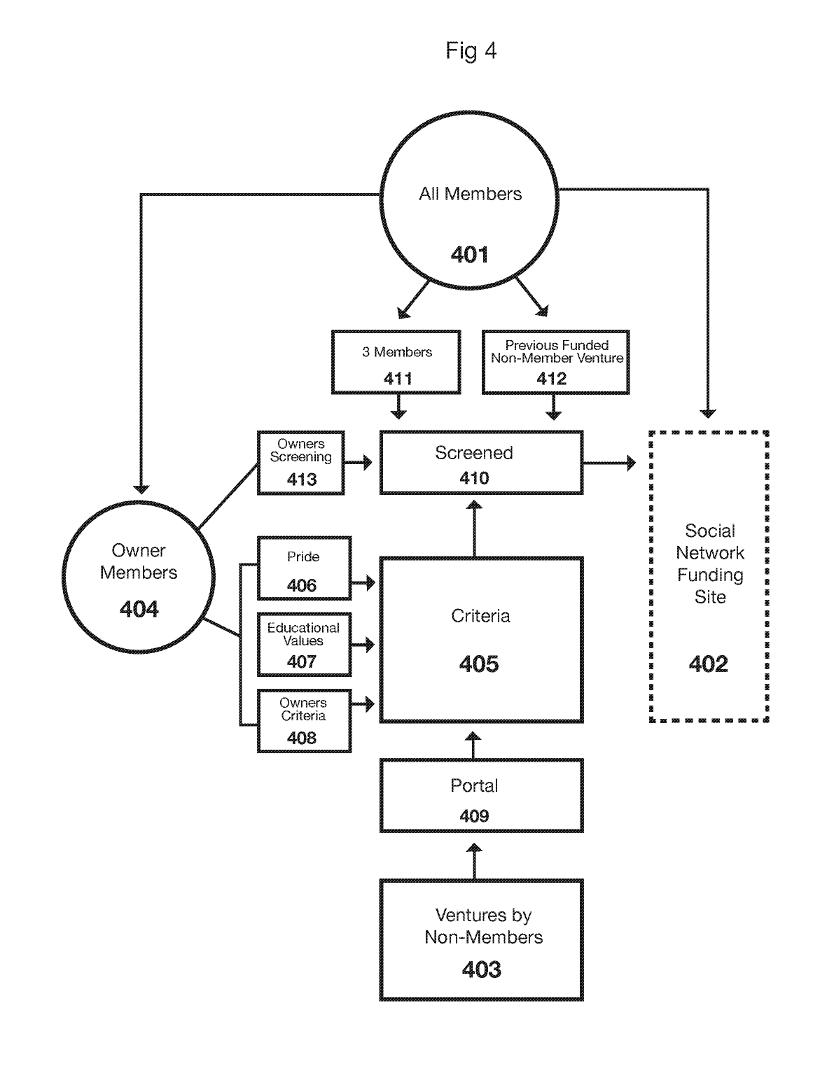

FIG. 4 illustrates how members 401 of a social network funding site 402 may fund ventures posted by non-members 403. The members who own a social network funding site 404 decide the criteria for ventures that they will accept from non-members 405. For example, members that own a doctors' social network funding site may only accept ventures from non-members which, if the venture succeeded, the funders would take pride in having supported 406. Or members that own a Harvard Alumni Association social network funding site may only accept ventures from non-members which, if the venture succeeded, would contribute to the support of educational values 407. Or members may establish other criteria selected by the owners 408. To do so, a portal is created 409, where non-members can submit ventures to the social network funding site 402. The ventures are screened 410 to establish whether they accord with the appropriate criteria 405. A possible method of screening is to send the proposal to three members of the social network site 411 chosen at random from all members 401 or chosen from those who had already funded a non-member venture 412 or whatever the owning members agree is a suitable method for screening 413. Once a non-member venture had passed the screening test it may be posted on the social network funding site 402 to solicit funds from the members 401.

### III. A SOCIAL NETWORK FUNDING SITE HAS TWO PLATFORMS AND TWO AFFINITIES

Another embodiment of this disclosure includes a social network funding with two platforms (members and non-members) and two affinities (related to members and non-members).

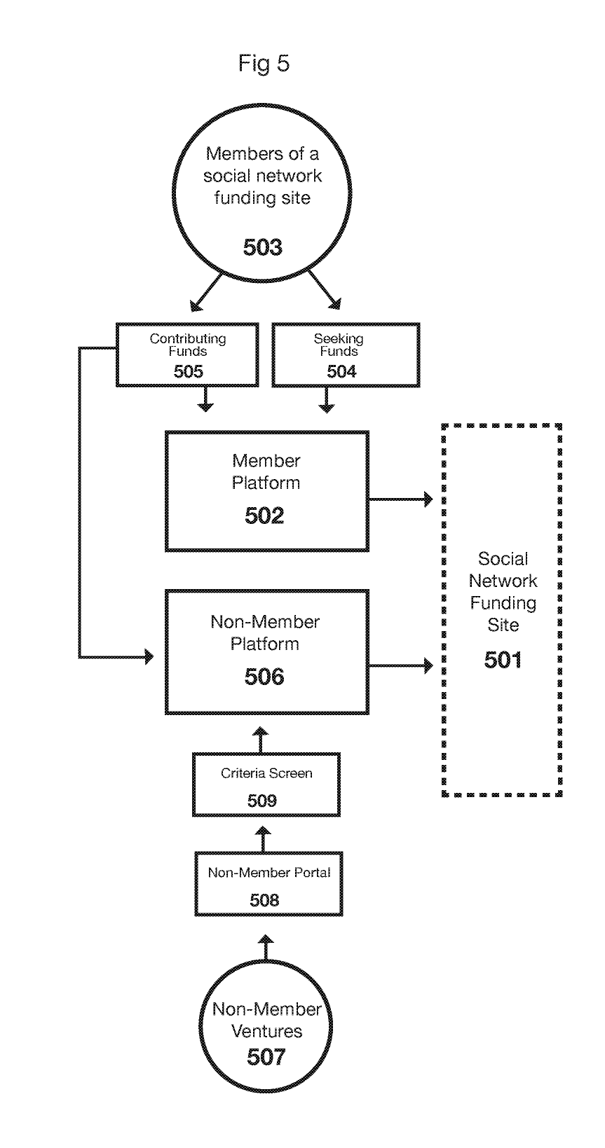

FIG. 5 illustrates how a social network funding site 501 may have two platforms. The member platform 502 is exclusively for the members 503 for posting ventures by members seeking funds 504 from members contributing funds 505. In this case, there are no criteria for selecting the ventures since any member is free to solicit funds from the other members. The non-member platform 506 is for ventures by non-members 507 which are submitted via the non-member portal 508. The non-member ventures are screened 509 to determine whether they comply with the criteria for non-member submissions. Those that are accepted are posted on the non-member platform 506 for funding by members 505. The two platforms attract different affinities. In the case of the member platform 502 there is an affinity for the individual 504 posting the venture because that individual is a member of the existing social network. In the case of the non-member platform there is an affinity for the venture 507 because the venture is in accord with the criteria 509 set by the members of the existing social network.

### IV. AN UMBRELLA PROVIDER TO SOLVE THE PRACTICAL AND ECONOMIC PROBLEMS OF CREATING AND MAINTAINING SOCIAL NETWORK FUNDING SITES

Another embodiment of this disclosure includes an umbrella provider that takes on support services necessary for the successful operation of a “reward”- or “equity”-based social network.

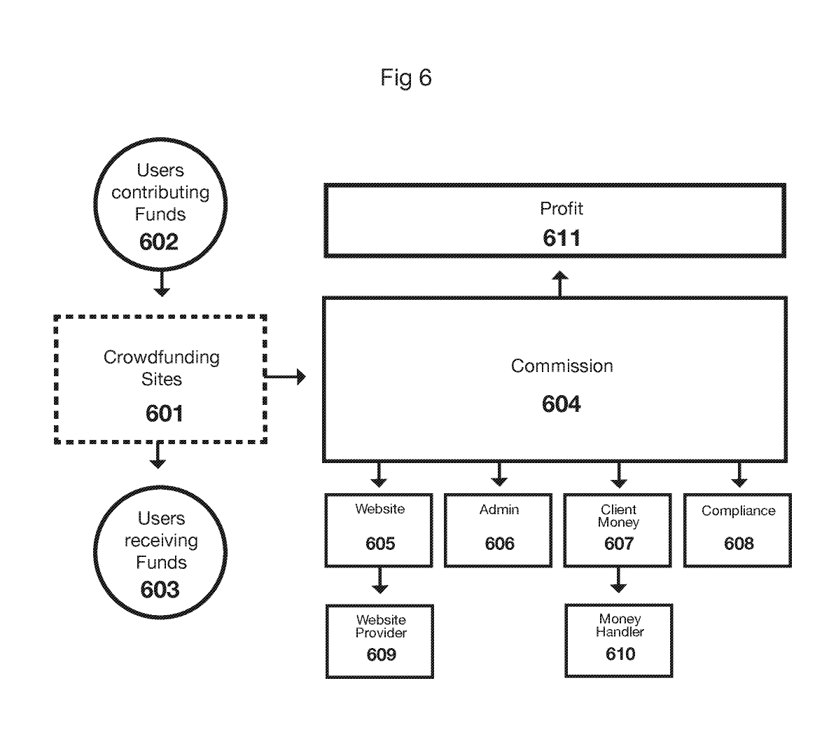

FIG. 6 illustrates the means by which most current crowd funding sites 601 generate the revenue to support their costs. When funds are passed from those users who fund a venture 602 to those users who are being funded for a venture 603, a commission 604 is charged on the sums disbursed. Investment and commission pay for website creation, design and maintenance 605, site administration 606, costs of handling client money 607, and, if required, regulatory compliance 608. To lessen start-up costs some crowd funding sites may outsource website creation, design and maintenance to a crowd funding website provider 609 To lessen ongoing costs, many crowd funding sites leave the handling of client money to a money collection and disbursement provider 610. After all costs are met, a major factor for most crowd funding sites is that there should also be a profit 611. It is the potential profit which drives the business plan when creating a new crowd funding site. Equity-based crowd funding sites require regulatory compliance 608 whereas reward-based crowd funding sites do not. In this application, “equity” encompasses anything which requires regulatory governance by, for example, the SEC in the USA or the FCA in the UK (e.g., shares, convertible notes, peer-to-peer lending).

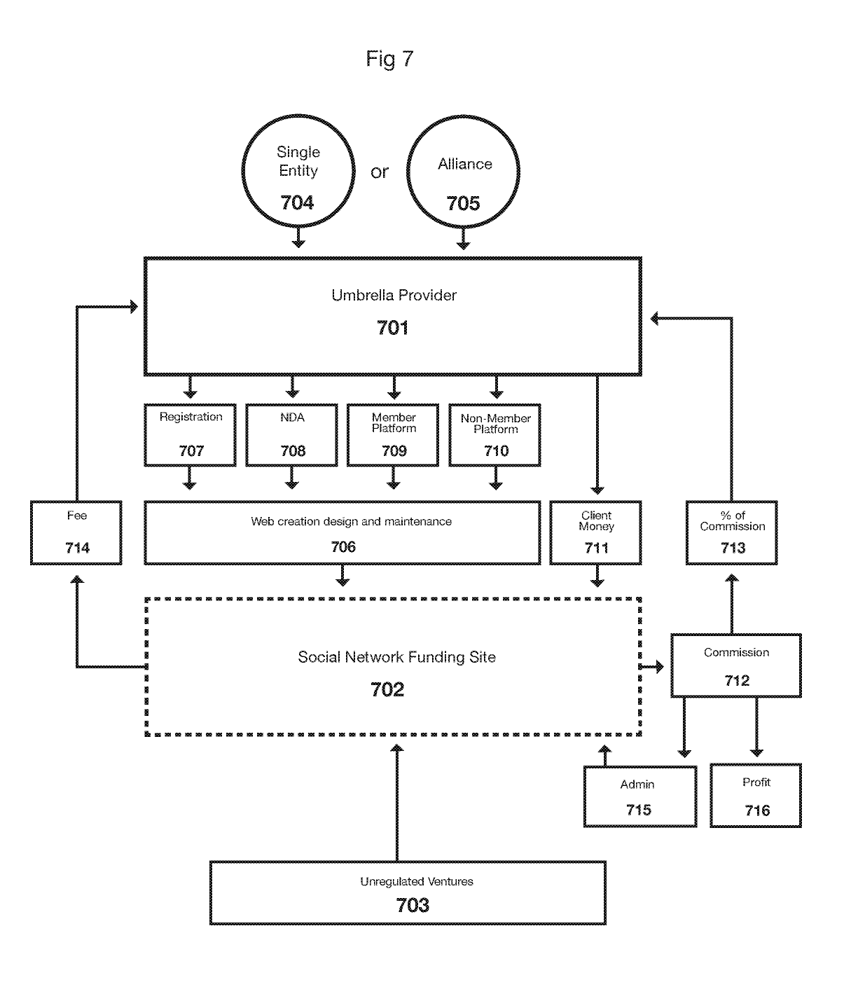

In general, social network funding sites are not primarily created for profit; they are created to serve the needs of their members who are both the users and owners of the site. As previously shown in FIG. 3, the founding members 305 provide the finance for creating the site; and thereafter the owners 302 have to ensure the finance for maintaining the site. In contrast, FIG. 7 illustrates a process by which an umbrella provider 701 may provide most of the services required by a social network funding site 702 to defray start-up and on-going costs for reward ventures i.e. unregulated ventures 703. The umbrella provider can be a single entity 704 or an alliance of independent providers 705. A social network funding site can outsource website creation, design and maintenance 706 to the umbrella provider. This website structure will differ from a crowd funding website structure because there will be a process which admits only individuals from the existing social network 707 and a process to require confidentiality in assessing the ventures 708 and one platform where members support ventures by members 709 and a second platform where members support ventures by non-members 710. A social network funding site can also outsource the handling of client money to the umbrella provider 711. So long as the ventures that are being funded are unregulated ventures, the social network funding site can set the commission 712. The umbrella provider 701 is compensated by receiving a percentage 713 of the commission 712 and/or by receiving a fee 714 related to traffic on the site or some other parameter. The umbrella provider offsets the costs of start-up and ongoing maintenance for the social network funding site; and so long as there is sufficient business on the site, the commission 712 should also cover the remaining administrative costs 715 of the site and possibly provide a profit 716.

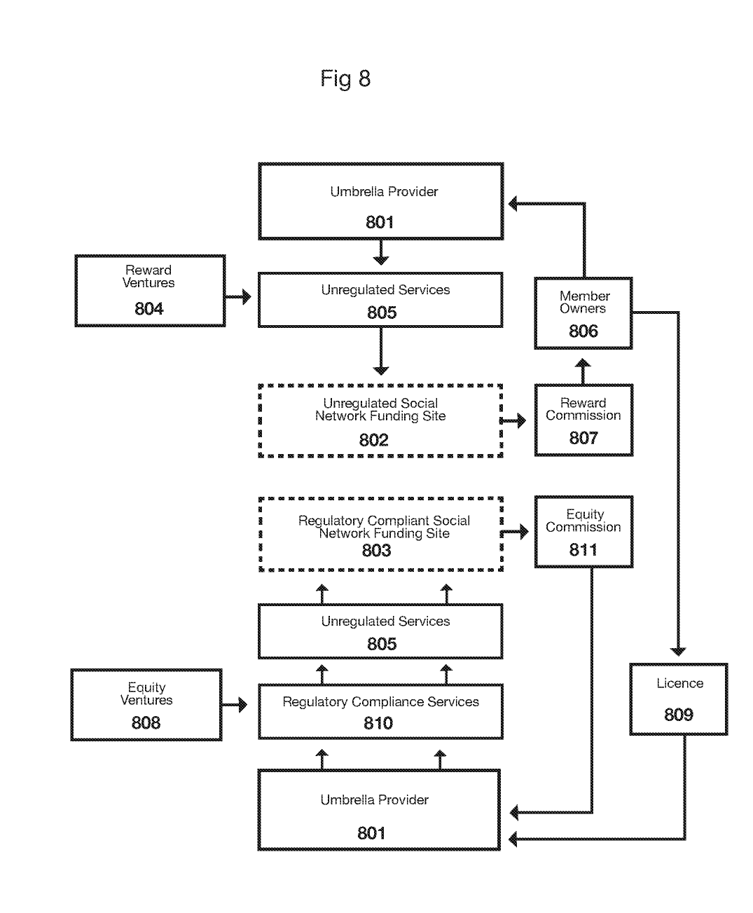

It is an important feature of a social network funding site that it is able to accept “equity” as well as “reward” ventures. The equity component allows members to solicit funds for small business ventures from other members and for non-members to propose innovative ventures under a non-disclosure agreement. Nonetheless, regulatory compliance for equity proposals is particularly demanding in time, money and expertise. FIG. 8 illustrates how an umbrella provider 801 might service both an unregulated social network funding site 802 and a regulatory compliant social network funding site 803 in parallel. For the reward (unregulated) ventures 804 whether by members or non-members, as shown in greater detail in FIG. 7, the umbrella provider provides the unregulated services 805. For these transactions, it is the owners of the social network funding site 806 who have full responsibility for setting the reward commission rate 807 and negotiating the terms and conditions for the unregulated services provided by the umbrella provider. For the equity (regulated) ventures 808, it would be cost effective for the umbrella provider to assume responsibility for the regulatory requirements of the site. The way that this can be structured will depend on the regulatory regime which governs equity transactions in any specific territory. For example in the UK the owners of the social network funding site 806 license the membership 809 to the umbrella provider 801 and it is the umbrella provider which performs the regulatory compliance procedures 810 on equity ventures by both members and non-members before the ventures are posted via its unregulated services 805 on the member and non-member platforms of the regulatory compliant social network funding site 803 which is owned, managed and the legal responsibility of the umbrella provider 801. For these equity transactions, the umbrella provider has full responsibility for setting and receiving the equity commission rate 811. Remuneration, if any, from the umbrella provider 801 to the owners of social network funding site membership 806 is governed by the license agreement 809.

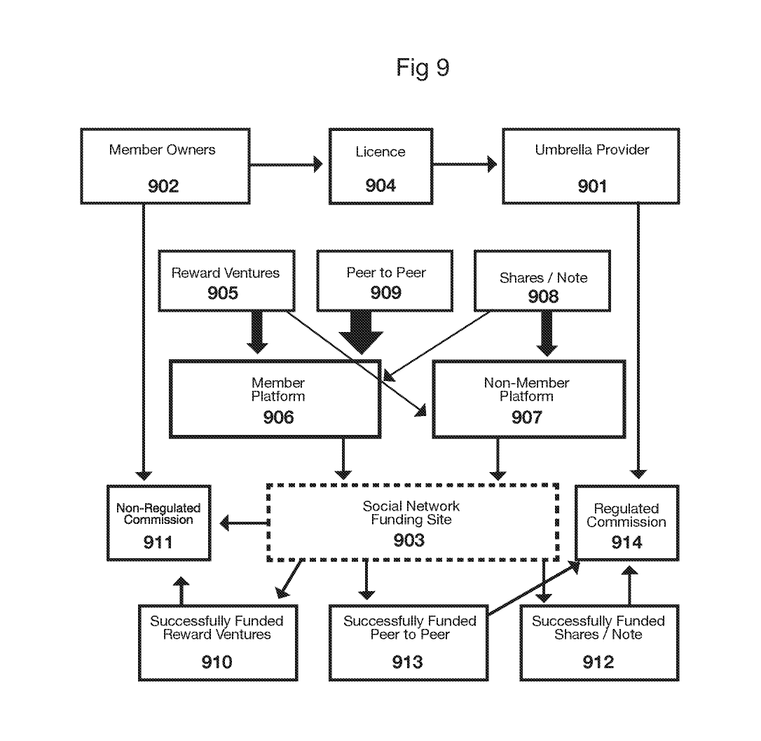

FIG. 9 illustrates a possible transaction flow to and from an umbrella provider 901 and the member owners 902 of a social network site 903 part of which is unregulated and owned by the owner members 902 and part of which is regulated and owned by the umbrella provider 901 under license 904 from the member owners. In this instance most reward ventures 905 are posted on the member platform 906 and some on the non-member platform 907. Most equity ventures consisting of share offerings and convertible notes 908 are posted on the non-member platform 907 with some on the member platform 906. Equity ventures consisting of peer to peer lending 909 would be posted on the member platform 906 as member to member lending. In this transaction flow, the successfully funded reward ventures 910 would have their non-regulated commission 911 set and managed by the owner members 902 of the social network funding site because they are non-regulated activities. The successfully funded equity transactions 912 and 913 would have their regulated commission 914 set, managed and owned by the umbrella provider 901 under the terms of the license agreement 904 because they are regulated activities.

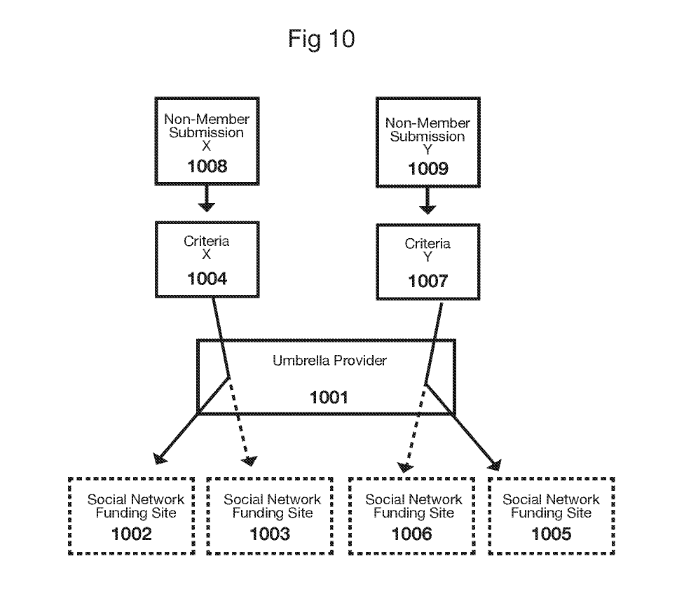

FIG. 10 illustrates the add-on benefit of an umbrella provider for social network funding sites. From the above, the more an umbrella provider 1001 can add social network funding sites to its umbrella, the more it can offer an economy of scale to the sites and profitability for them and for itself. Moreover, there is a further add-on benefit for the sites that are served by an umbrella. In one example, there may be two social network sites 1002 and 1003 which share common criteria (criteria X) 1004 for accepting non-member submissions and two other social network sites 1005 and 1006 which share a different common criteria (criteria Y) 1007 for accepting non-member submissions. If a non-member submission (submission X) 1008 is successfully posted on the non-member platform of social network site 1002, it may be posted simultaneously on social network site 1003 and all other sites which have agreed via the umbrella to share non-member submissions which satisfy criteria X 1004. Similarly if a non-member submission (submission Y) 1009 is successfully posted on the non-member platform of social network site 1005, it may be posted simultaneously on social network site 1006 and all other sites which have agreed via the umbrella to share non-member submissions which satisfy criteria Y 1007. The sharing of successful submissions by non-members across a number of different social network funding sites increases the possibility of those ventures being funded, and the members of the different funding sites successfully participating in funding the ventures which are posted on their sites by non-members. An umbrella provider 1001 can facilitate this process subject to the agreement of the various sites which share common criteria.

### V. NON-FINANCIAL SUPPORT BETWEEN MEMBERS

In another embodiment, there can be non-financial support between members in the form of targeted messaging.

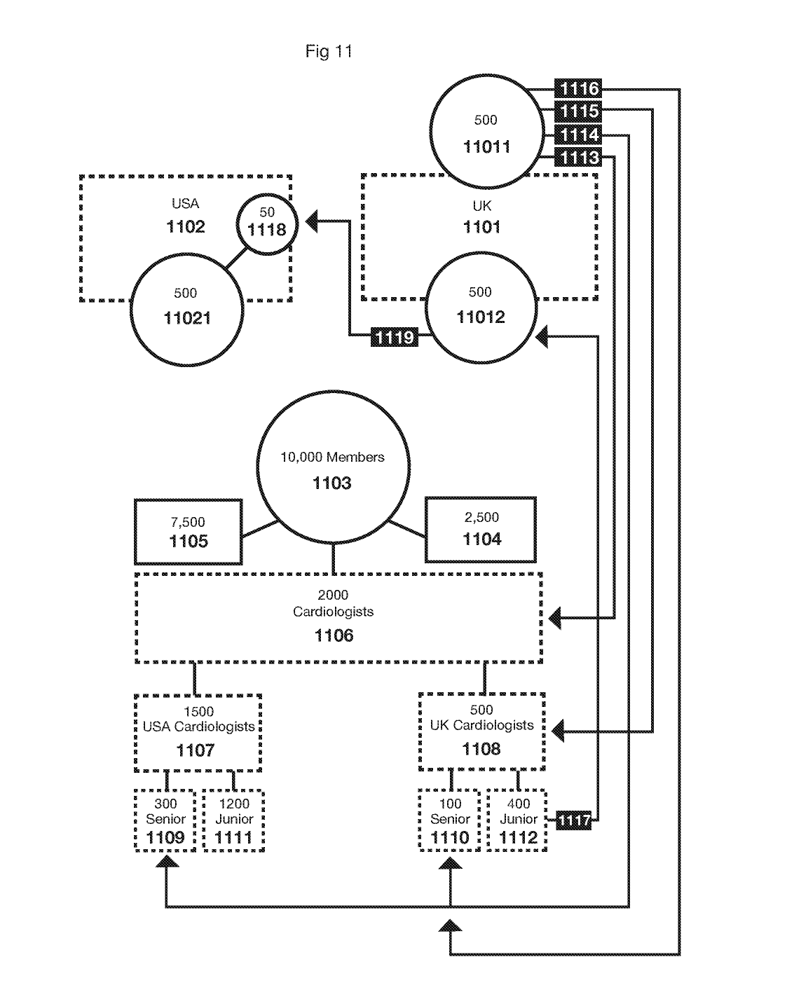

On creation of an account, the potential member of an existing social network will provide critical data items, and be reminded (from time to time) to keep the items updated. FIG. 11 indicates how this might operate for an existing social network consisting of medical doctors. The critical data items would be:

1. Location (Town, State, Country). This is the geographical area in which the doctor works, with more than one location permitted, and easily changeable. In FIG. 11, there are two countries, the UK 1101 and the USA 1102. The locations are:

i. Edinburgh, Scotland, UK 11011

ii. Birmingham, England, UK 11012

iii. Austin, Tex., USA 11021

2. Interest (Speciality/Field). This is the member's special interest (e.g. cardiology, neurology, general medicine, etc.), with more than one interest permitted

3. Expertise (Position/Seniority). This is the member's level of professional practice within the hierarchy of their interest from senior to junior. For example in the UK, it could be GP/consultant, senior registrar, registrar, SHO, Fl, and/or others

Now let us suppose there are a total of 10,000 members 1103 who have created an account on a medical doctor social network non-financial support site, 2,500 in the UK 1104 and 7,500 in the USA 1105 and 500 each in Edinburgh 11011, Birmingham 11012 and Austin 11021. Let us suppose that 20% of the total membership is cardiologists 1106 (2,000) and that 75% are in the USA 1107 (1,500) and 25% in the UK 1108 (500); and that 20% of the cardiologists are senior 1109 (300) and 1110 (100), and 80% are junior 1111 (1,200) and 1112 (400).

International, national and local targeted messaging could operate as follows:

1. A doctor in Edinburgh 11011 is a senior cardiologist.

i. Hosting an international cardiology conference sends a targeted message 1113 about the conference to the 2,000 cardiologists in the membership 1106 or sends a targeted message 1114 about the conference only to the 400 senior cardiologists in the membership 1109 (300) and 1110 (100).

ii. Hosting a national cardiology conference sends a targeted message 1115 about the conference to the 500 cardiologists in the UK 1108.

iii. Requires a locum while on leave sends a targeted message 1116 seeking a locum replacement to the 100 senior cardiologists in the UK 1110.

2. A junior cardiologist in the UK 1112 is about to relocate for further training in Birmingham 11012 and sends a targeted message 1117 to all 500 doctor members in the Birmingham area 11012 requesting assistance for finding accommodation

Let us suppose that of the 500 members in Austin 11021, there are 50 who are neurologists 1118.

Local to local international targeted messaging could operate as follows:

A doctor in Birmingham 11012 is a neurologist taking a family holiday in Austin and wants to visit some neurology facilities during the vacation and sends a targeted message 1119 asking to visit their workplace to the 50 neurologists in Austin 1118.

There would need to be an inducement to encourage members to target their message to suitable recipients, rather than allowing a scatter gun approach of sending to all members and leaving it up to the targeted members to respond. This embodiment can be employed so that the sender is encouraged to limit the recipients of the message on a cost basis; i.e. the less the number targeted, the lower the cost. This is possible because the embodiment will allow the sender to know in advance how many members are being targeted by their message. For example, instead of sending to all 20,000 members, message 1113 targets 2,000; message 1114 targets 400; message 1115 targets 500; message 1116 targets 100; message 1117 targets 500; and message 1119 targets 50. Senders can modify their recipient list to maximise its cost effectiveness.

If the recipient list was too large (i.e. too costly) for the sender even with careful targeting, another embodiment would be to allow the target to be maintained but the numbers within the target to be reduced by a sliding scale e.g. from 100% of the targeted members down to (say) 10% of the targeted members selected at random from the target group.

### VI. CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
creating a restricted website that is open only to members of a social network, wherein the restricted website is created by a first member of the social network;
registering a second member of the social network with the restricted website;
wherein the registering the second member of the social network comprises a verification step and a confidentiality step;
wherein the verification step comprises a confirmation that the second member of the social network is a genuine member of the social network;
wherein the confidentiality step comprises a confidentiality agreement entered into by the second member of the social network.

2. The method as in claim 1, further comprising:
soliciting funds for a venture by a third member of the social network, wherein the third member may be the same person as the first member or the second member.

3. The method as in claim 2, further comprising:
contributing funds to the venture by a fourth member of the social network, wherein the fourth member may be the same person as the first member, the second member or the third member.

4. The method as in claim 1, further comprising:
sharing ownership of the restricted website with a fifth member of the social network, wherein the fifth member may be the same person as the second member, the third member or the fourth member.

5. The method as in claim 4, wherein sharing ownership comprises the use of a holding entity.

6. The method as in claim 4, wherein sharing ownership comprises the use of shares.

7. The method as in claim 4, wherein the sharing ownership includes all members of the social network.

8. The method as in claim 4, wherein the sharing ownership includes the use of a subscription requirement.

9. The method as in claim 4, wherein sharing ownership includes determining which members contribute to the success of the venture.

10. The method as in claim 2, wherein the venture is selected from the group consisting of an equity-based venture and a reward-based venture;
wherein the equity-based venture is regulated by a governmental entity;
wherein the reward-based venture is not regulated by the governmental entity.

11. The method as in claim 3, wherein the venture is selected from the group consisting of an equity-based venture and a reward-based venture;
wherein the equity-based venture is regulated by a governmental entity;
wherein the reward-based venture is not regulated by the governmental entity.

12. A method comprising:
creating a restricted portal that is open to non-members of a social network, wherein the restricted portal is created by at least one member of the social network;
creating selection criteria by at least one member of the social network for non-member ventures
posting the non-member venture of the social network for the at least one member of the social network via the restricted portal;
filtering the non-member venture to determine if the selection criteria are met.

13. The method as in claim 12 wherein the filtering is determined by the at least one member of the social network.

14. The method as in claim 13, wherein the at least one member of the social network is chosen randomly.

15. The method as in claim 13, further comprising:
if the selection criteria are met, soliciting funds for the venture from the at least one member of the social network.

16. The method as in claim 15, further comprising:
contributing funds for the venture by the at least one member of the social network.

17. A method comprising:
creating a member platform for a member venture posted by at least one member of a first social network seeking member funds from the at least one member of the first social network;
creating a non-member platform for a non-member venture posted by a non-member of the first social network seeking member funds from the at least one member of the first social network;
screening the non-member venture to determine whether the non-member venture complies with criteria for non-member submissions on the first social network.

18. The method as in claim 17, further comprising:
establishing an umbrella provider for providing network services to support the first social network.

19. The method as in claim 18, wherein the network services include regulatory services related to the first social network.

20. The apparatus as in claim 18 wherein the networks services include posting the non-member venture on a second social network.
